(19) United States
(12) Patent Application Publication
(10) Pub. No.: US 2009/0090020 A1
(43) Pub. Date: Apr. 9, 2009

(54) Dryer and Control Method of Drying Time for the Same

(76) Inventors: Yeon Sik Choi, Gyeongsangnam-do (KR); Myoung Jong Kim, Gyeongsangnam-do (KR)

Correspondence Address: MCKENNA LONG & ALDRIDGE LLP, 1900 K STREET, NW, WASHINGTON, DC, 20006, US

(21) Appl. No.: 12/224,952

(22) PCT Filed: Mar. 14, 2007
(86) PCT No.: PCT/KR2007/001257

§ 371 Date: Sep. 10, 2008

(30) Foreign Application Priority Data
Mar. 14, 2006 (KR) 10-2006-0023666

(51) Int. Cl. F26B 19/00; F26B 3/02; F26B 21/08; D06F 58/00

(52) U.S. Cl. 34/88; 34/443; 34/557; 34/130

(57) ABSTRACT

Dryer and method for controlling a drying time period which enables to indicate an increased remained drying time period to a user. The method includes the steps of re-setting a remained drying time period, and informing user an increased remained drying time period, whereby permitting to prevent the user from misunderstanding that the dryer is out of order.

### TECHNICAL FIELD

The present invention relates to a dryer and a method for controlling a drying time period, and more particularly, to a dryer and a method for controlling a drying time period, which enables a user to know a change of a drying time period.

### BACKGROUND ART

In general, the dryer dries a washed wet drying object automatically, and has the following system.

FIG. 1 illustrates a diagram showing a system of a related art dryer, schematically.

Referring to FIG. 1, the related art dryer is provided with an input unit 201 for inputting a setting value, a display unit 203 for displaying drying and cooling states from the set values at the input unit 201. The related art dryer is also provided with a humidity sensing unit 205 for sensing humidity of an inside of the drum during drying, a temperature sensing unit 207 for sensing a temperature of the inside of the drum during the drying and cooling, and a microcomputer 209 for controlling the drying and cooling with reference to information received from the input unit 201 and the sensing units. The related art dryer is also provided with a heater and motor driving unit 213 for performing the drying and cooling under the control of the microcomputer 209, and a power source unit 211 for applying power to the heater and motor driving unit 213 and the microcomputer 209.

The microcomputer 209 receives information on an inside of the drum from the humidity sensing unit 205 and the temperature sensing unit 207, to determine a drying state of the drying object, and controls the heater and motor driving unit 213 which performs the drying by using devices such as the heater and the motor according to a result of the determination.

A method for controlling a drying time period of the related art dryer will be described.

FIG. 2 illustrates a flow chart showing the steps of a process for controlling a drying time period in the related art dryer.

Referring to FIG. 2, drying is started (S210) as the user introduces the drying object into the dryer, and operates the input unit 210 to put the beater and motor driving unit 213 into operation.

In this instance, the temperature sensing unit 207 measures a drying starting temperature at the same time with the starting of drying.

After starting of the drying, a time period is measured in which an intermediate temperature of the drying starting temperature and a preset highest drying temperature is reached (S220), and a remained drying time period in which the driving unit is to be operated is re-set by using a preset times of the time period in which the intermediate temperature is reached (S230).

Then, in performing the drying (S240), the drying is performed for the remained drying time period re-set thus, and the drying is finished (S260).

In a case the drying is finished thus, operation of the heater and motor driving unit 213 is stopped and cooling is started.

Finally, by displaying the finish of the drying on the display unit 203, the microcomputer 209 lets the user to know that the drying is finished.

Referring to FIG. 3, if the drying is started in the drying process, the microcomputer can read humidity and temperature the humidity sensing unit 205 and the temperature sensing unit 207 sensed as time passes by (a solid line is a curve denoting a humidity change, and a dashed line is a curve denoting a temperature change).

It can be known from the curves 400 and 500 of humidity and temperature changes sensed at the humidity sensing unit 205 and the temperature sensing unit 207 that, since the humidity drops while the temperature rises as the time passes by, heights of the curves 400 and 500 are reversed.

The dryer can change the drying time period by sensing a temperature change as time passes by, measuring a time period for reaching to the intermediate temperature that is an intermediate value of a drying starting temperature and a highest drying temperature, and using the time period in which the intermediate value of the starting temperature and the highest temperature is reached. Change of the drying time period is possible with a data measured at the humidity sensing unit 205 instead of the temperature sensing unit 207 in the drying process.

Once the drying is started the highest drying temperature (approx. 70° C.) can be reached from a room temperature (approx. 20° C.) as time passes by. The highest drying temperature is stored in the microcomputer 209 in advance.

For an example, once the drying is started, the drying can be made by measuring a time period Δt1 in which the intermediate temperature 45° C. of the drying starting temperature and the highest drying temperature is reached, and taking a value obtained by multiplying a preset value to the time period Δt1 in which the intermediate temperature 45° C. is reached as the remained drying time period Δt2 for driving the driving unit.

If a drying time period which is set according to measurement of a water content of the drying object at an initial stage of operation increases through a re-setting step such as one described above, the microcomputer 209 of the related art dryer fixes the drying time period displayed on the display unit 203 at a certain time point, and lets the drying time period on the display unit 203 lapse again according to a flow of time again after lapse of the time period as much as an added time period. The time point of the drying time period on the display unit 203 fixed thus is, in general, six minutes before finish. In the meantime, the drying time period increased as much as the added time period may be displayed on the display unit 203.

However, in a method for controlling a drying time period in the related art dryer, if the remained drying time period increases, because either the drying time period displayed on the display unit is changed or the drying time period displayed on the display unit is fixed for a preset time period, there have been many cases when the user complains on out of order of the dryer.

### DISCLOSURE OF INVENTION

### Technical Problem

An object of the present invention devised to solve the problem lies on providing a dryer and a method for controlling a drying time period which enables to inform to a user for the user not to misunderstand that the dryer is out of order when a drying time period is increased.

### Technical Solution

To achieve these objects and other advantages and in accordance with the purpose of the invention, as embodied and broadly described herein, a method for controlling a drying time period in a dryer includes the steps of re-setting a remained drying time period, and informing user an increased remained drying time period.

Preferably, the re-setting step is repeated at least once.

The informing step is made if the remained drying time period is increased more than a predetermined time period T.

The informing step includes the step of indicating to a user with a visible medium.

The informing step includes the step of displaying a mark which indicates the remained drying time period and a mark which indicates an increased remained drying time period at the same time.

Preferably, the mark is displayed on one side of a region where the remained drying time is displayed.

In the meantime, the mark is movable.

The informing step includes the step of displaying the mark which indicates the remained drying time period and a mark which indicates the increased remained drying time period, alternately.

In another aspect of the present invention, a dryer includes a temperature sensing unit for sensing an inside temperature of a drum, a microcomputer for receiving a temperature from the temperature sensing unit sensed thus for controlling a system, and a display unit having a region for displaying a remained drying time period and a region for displaying a mark which informs an increased remained drying time period, for providing information on a system controlled by the microcomputer.

Preferably, the dryer further includes a humidity sensing unit measuring a water content of a drying object and providing to the microcomputer.

In another aspect of the present invention, a dryer includes a temperature sensing unit sensing an inside temperature of a drum, a microcomputer receiving a temperature from the temperature sensing unit sensed thus for controlling a system, and a display unit displaying a frame which informs a remained drying time period and a frame which informs a mark that indicates a system is in operation, alternately.

Preferably, the alternation of the frames are made within a period of two seconds.

### BRIEF DESCRIPTION OF THE DRAWINGS

FIG. 1 illustrates a block diagram of a related art dryer, schematically.

FIG. 2 illustrates a flow chart showing the steps of a method for controlling a drying time period of a related art dryer.

FIG. 3 illustrates a graph representing characteristics of a drying object in drying.

FIG. 4 illustrates a diagram showing a method for controlling a drying time period in a dryer in accordance with a first preferred embodiment of the present invention.

FIG. 5 illustrates a diagram showing a method for controlling a drying time period in a dryer in accordance with a second preferred embodiment of the present invention.

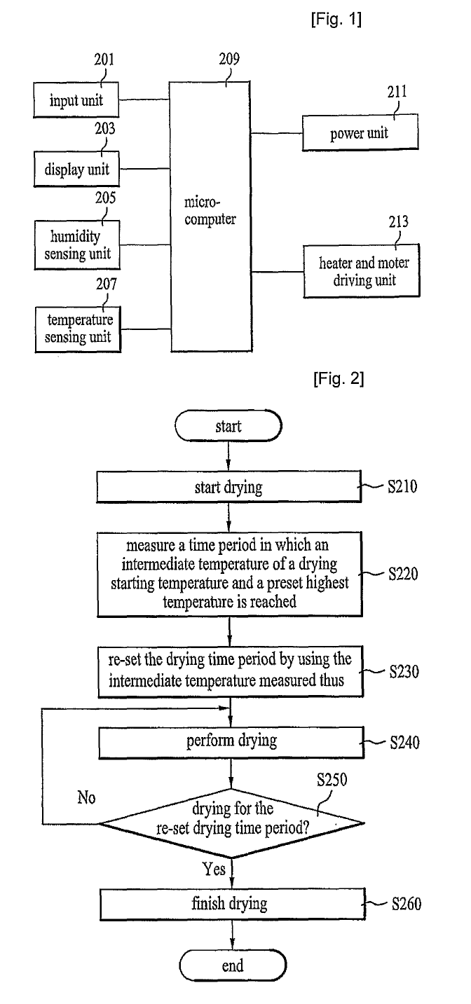

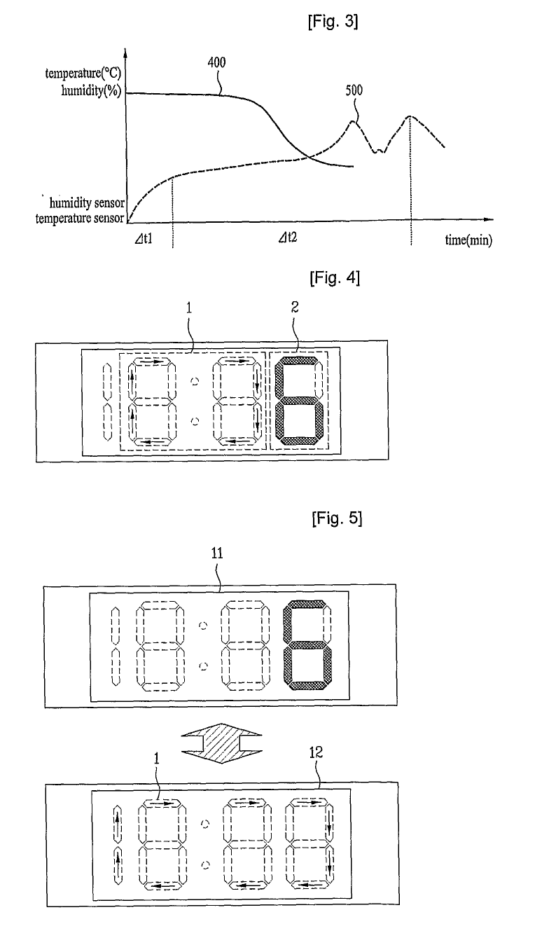

### BEST MODE FOR CARRYING OUT THE INVENTION

Reference will now be made in detail to the preferred embodiments of the present invention, examples of which are illustrated in the accompanying drawings.

Descriptions of parts the same with the related art dryer and a method for controlling the same will be omitted and wherever possible, the same reference numbers will be used throughout the drawings to refer to the same or like parts.

Once the drying of the dryer is started, a time period is measured in which an intermediate temperature of the drying starting temperature and the highest drying temperature is reached, and a remained drying time period is set by taking a value obtained by multiplying a preset value to the time period measured thus in which the intermediate temperature is reached.

However, it is possible that, not necessarily limiting to measuring of the time period in which the intermediate temperature is reached, but a range from the drying starting temperature to the highest drying temperature is divided with n equally, and the remained drying time period can be set again at every time when each of the n equally divided temperature is reached.

If the remained time period increases as the time period required to reach to the temperature is prolonged, in the present invention, a method is used, in which the remained drying time period displayed on the display unit 203 is fixed at a predetermined time point, and lapse of time as much as an added time period is waited.

FIGS. 4 and 5 each illustrates a method for controlling a drying time period in a dryer in accordance with a preferred embodiment of the present invention which is preformed after the re-setting of the remained time period is made.

A method for controlling a drying time period in a dryer in accordance with a first preferred embodiment of the present invention will be described with reference to FIG. 4.

For an example, if it is assumed that a total drying time period set initially is 50 minutes, a time period required to reach to the intermediate temperature is 30 minutes, and a remained drying time period is 20 minutes, if unity is multiplied to 30 minutes which is the time period required to reach to the intermediate temperature for setting the remained time period, the remained time period is changed to 30 minutes. However, since the remained time period displayed on the display unit 203 presently, it is required that the time displayed on the display unit 203 is fixed for 10 minutes.

However, if the fixing of the time is to continue for more than a predetermined time period T, for an example, 30 seconds, a specific symbol 1 is displayed in a state the displayed time is fixed, so that the user knows that the drying course is being delayed. Though it is preferable that the predetermined time period T is one minute which is a level the user senses, the predetermined time period T may be changed taking a total time period into account. As means for informing the delay of the drying course to the user, sound may be used instead of the symbol.

It is preferable that the symbol 1 is displayed on a left side or right side of the time display region 2 of the display unit 203 adjacent thereto. Because, if the symbol is at a place where the user pays attention for determining the remained drying time period, the symbol can be found easily.

Even though it is preferable that the symbol is a mark in a shape in FIG. 4 which indicates that the dryer is in operation, a character may be used. The symbol 1 may be flashing entirely, or flashing in a direction in succession, or fixed.

If the time period added to the initially set drying time period is passed fully, the symbol 1 is erased, and only the remained time period is displayed as displayed originally.

A method for controlling a drying time period in a dryer in accordance with a second preferred embodiment of the present invention will be described with reference to FIG. 5.

Referring to FIG. 5, if it is required that the display unit 203 is fixed for more than the predetermined time period T, the microcomputer 209 outputs a remained time period output frame 11 and a specific symbol output frame 12 which represents the dryer in operation, alternately. Even though it is preferable that the predetermined time period T is one minute which is a level the user can sense, the predetermined time period can be changed taking an entire drying time period into account.

It is preferable that a time period of the frame alternation is within two seconds which is a time period the users can sense the alternation of the frame. However, if frequent alternation of the frame causes an excessive power consumption, the period of the frame alternation may be determined, taking the excessive power consumption into account. Alike the first embodiment, the symbol 1 may be flashed, or fixed.

Since the user can determine addition of the drying time period easily, the present invention can prevent the user from misunderstanding that the dryer is out of order.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

Since the user can determine addition of the drying time period easily, the dryer and the method for controlling a drying time period in a dryer of the present invention can prevent the user from misunderstanding that the dryer is out of order.

1. A method for controlling a drying time period in a dryer comprising the steps of:
re-setting a remained drying time period; and
informing user an increased remained drying time period.

2. The method as claimed in claim 1, wherein the re-setting step is repeated at least once.

3. The method as claimed in claim 1, wherein the informing step is made if the remained drying time period is increased more than a predetermined time period T.

4. The method as claimed in claim 3, wherein the informing step includes the step of indicating to a user with a visible medium.

5. The method as claimed in claim 4, wherein the informing step includes the step of displaying a mark the remained drying time period and a mark which indicates an increased remained drying time period at the same time.

6. The method as claimed in claim 5, wherein the mark is displayed on one side of a region where the remained drying time is displayed.

7. The method as claimed in claim 6, wherein the mark is movable.

8. The method as claimed in claim 4, wherein the informing step includes the step of displaying the remained drying time period and a mark which indicates the increased remained drying time period alternately.

9. A dryer comprising:
a temperature sensing unit sensing an inside temperature of a drum;
a microcomputer receiving a temperature from the temperature sensing unit sensed thus for controlling a system; and
a display unit having a region displaying a remained drying time period and a region for displaying a mark which informs an increased remained drying time period, for providing information on a system controlled by the microcomputer.

10. The dryer as claimed in claim 9, further comprising a humidity sensing unit measuring a water content of a drying object and providing to the microcomputer.

11. A dryer comprising:
a temperature sensing unit sensing an inside temperature of a drum;
a microcomputer receiving a temperature from the temperature sensing unit sensed thus for controlling a system; and
a display unit displaying a frame which informs a remained drying time period and a frame which informs a mark that indicates a system is in operation, alternately.

12. The dryer as claimed in claim 11, wherein the alternation of the frames are made within a period of two seconds.
